(19) United States
(12) Patent Application Publication
(10) Pub. No.: US 2018/0230359 A1
(43) Pub. Date: Aug. 16, 2018

(54) THICKENING TIME AID

(71) Applicant: SOLVAY USA INC., Princeton, NJ (US)

(72) Inventors: Enrique LOPEZ, Midland, TX (US); Tyler Heath NELSON, Midland, TX (US); John NEUFELD, Andrews, TX (US)

(73) Assignee: SOLVAY USA INC., Princeton, NJ (US)

(21) Appl. No.: 15/897,415

(22) Filed: Feb. 15, 2018

Related U.S. Application Data
(60) Provisional application No. 62/459,196, filed on Feb. 15, 2017.

(51) Int. Cl. C09K 8/467; C04B 28/04; C04B 22/14; E21B 33/14

(52) U.S. Cl. CPC C09K 8/467; C04B 28/04; C04B 2103/44; E21B 33/14; C04B 22/143

(57) ABSTRACT

Methods for achieving thickening time in cement compositions that would otherwise be unable to achieve at least 70 Bc in the absence of the thickening time modifiers described herein.

### CROSS-REFERENCE TO RELATED APPLICATION

The present application claims the benefit of priority under 35 U.S.C. § 119(e) of U.S. Provisional Application Ser. No. 62/459,196, filed on Feb. 15, 2017, the entire disclosure of which is incorporated herein by reference.

### BACKGROUND

In cementing methods, such as well construction and remedial cementing, settable compositions are commonly utilized. As used herein, the term “settable composition” refers to a composition(s) that hydraulically sets or otherwise develops compressive strength. Settable compositions may be used in primary cementing operations whereby pipe strings, such as casing and liners, are cemented in well bores. In performing primary cementing, a settable composition may be pumped into an annulus between a subterranean formation and the pipe string disposed in the subterranean formation or between the pipe string and a larger conduit disposed in the subterranean formation. The settable composition should set in the annulus, thereby forming an annular sheath of hardened cement (e.g., a cement sheath) that should support and position the pipe string in the well bore and bond the exterior surface of the pipe string to the walls of the well bore or to the larger conduit. Settable compositions also may be used in remedial cementing methods, such as the placement of cement plugs, and in squeeze cementing for sealing voids in a pipe string, cement sheath, gravel pack, formation, and the like. Settable compositions may also be used in surface applications, for example, construction cementing.

Settable compositions for use in subterranean formations may include a cementitious component which hydraulically sets, or otherwise hardens, to develop compressive strength. The cementitious component is typically pumped into place. The ability of a cement composition to be pumped in a wellbore is related to the consistency of the composition, which is measured in Bearden units of consistency (Bc), a dimensionless unit with no direct conversion factor to the more common units of viscosity. The “thickening time” is the length of time for a cement composition to become unpumpable at a specified temperature and specified pressure. A cement composition becomes “unpumpable” when the consistency of the composition reaches 70 Bc.

Frequently, the cement slurry is prepared with a high water to cement ratio in order to increase the yield and decrease the density and cost of a cementing operation. However, as the water to cement ratio of the slurry increases, the slurry become less likely to achieve at least 70 Bc, due to the high water ratio and in part to the increased distance between cement particles as they hydrate. In such situations, the reported thickening time is often estimated or projected from the thickening time chart which has not achieved a thickening time of 70 Bc which is inaccurate and can lead to failed cementing operations.

### SUMMARY

The present disclosure provides methods for achieving thickening time in cement compositions that would otherwise be unable to achieve at least 70 Bc in the absence of the thickening time modifiers described herein.

### BRIEF DESCRIPTION OF THE DRAWINGS

FIG. 1 provides a thickening time chart for Composition 1.

FIG. 2 provides a thickening time chart for Composition 2.

FIG. 3 provides a thickening time chart for Composition 3.

### DETAILED DESCRIPTION

In general, methods according to the present disclosure are used to achieve at least 70 Bc, preferably between 70 Bc and 100 Bc, and include the steps of providing a cementitious composition, which includes a cement mix and a thickening time modifier selected from calcium sulfate hemihydrate, calcium sulfate dihydrate, anhydrous calcium sulfate, and combinations thereof; combining the cementitious composition with water in an amount from about 140 wt % to about 300 wt % by weight of cement (BWOC) to form a slurry; and allowing the slurry to achieve at least 70 Bc.

As used herein, the consistency of a cement composition is measured according to ANSI/API Recommended Practice 10B-2. For example, the cement composition is mixed and then placed in the test cell of a High-Temperature, High-Pressure (HTHP) consistometer, such as a Fann Model 275 or a Chandler Model 8240. The cement composition is tested in the HTHP consistometer at the specified temperature and pressure. Consistency measurements are taken continuously until the consistency of the cement composition attains or exceeds 70 Bc or the test is otherwise terminated.

In general, the concentration of thickening time modifier does not need to be excessive to the extent that it increases the viscosity of the cement slurry so that it is not capable of being pumped, imparts excessive viscosity resulting in high friction pressures during pumping or induces thixotropic properties to the cement slurry, i.e., the viscosity increases significantly to yield a slurry that will not pour or is near to that state when the slurry is at static. In an embodiment, the thickening time modifier is present in an amount from about 1 wt % to about 20 wt % by total weight of the composition. In another embodiment, the thickening time modifier is present in an amount from about 1 wt % to about 8 wt % by total weight of the composition. In another embodiment, the thickening time modifier is present in an amount from about 5 wt % to about 20 wt % by total weight of the composition.

Cement mixes useful in the present disclosure include, for example, cements containing silica fume. In an embodiment, the cement mix is selected from Portland cement, pozzolana cement, gypsum cement, alumina cement, silica cement, slag cement, and high alkalinity cement. Special grinds of cement such as micro-fine cement and fine grind lightweight type cements and/or shale mixtures may be used.

Optionally, compositions used in the present disclosure include one or more commonly used cement additives. In an embodiment, the cementitious composition further includes one or more additives selected from extenders, accelerators, retarders, fluid loss agents, rheology modifiers, gas migration additives, expansion additives, anti-settling additives, compressive strength enhancers, loss circulation additives, and combinations thereof.

Also provided are methods for cementing that include the steps of introducing a cement slurry into a wellbore penetrating a subterranean formation, wherein the slurry includes a cement mix, a thickening time modifier selected from calcium sulfate hemihydrate, calcium sulfate dihydrate, anhydrous calcium sulfate, and water in an amount from about 140 wt % to about 300 wt % by weight of cement; and allowing the slurry to set therein.

In an embodiment, the slurry is allowed to set in a space between the subterranean formation and a pipe string. In another embodiment, the cement slurry is introduced into leak paths in a cured cement sheath in the subterranean formation and allowed to set in the leak paths. In an embodiment, the cement slurry is allowed to set into a solid mass which forms a plug in the wellbore.

In an embodiment, the method further includes the step of introducing an aqueous spacer fluid into the wellbore prior to introducing the cement slurry. In another embodiment, the cement slurry is selected from a lead slurry (e.g. to be placed in the upper section of a wellbore), a tail slurry (e.g. to be placed in the lower section of a wellbore), a completion slurry (e.g. to seal the annulus adjacent to the productive zone), a scavenger slurry, a plug slurry, a squeeze slurry, and a liner slurry. As used herein, the term “scavenger slurry” refers to aqueous suspensions of solids such as (but not limited to) Portland cement, and frequently contain customary cement additives such as (but not limited to) retarders, fluid-loss additives and dispersants. Cement spacers and scavenger cement systems are used to aid separating drilling fluid from the cement slurry. As used herein, the term “plug slurry” refers to a cement slurry that is placed in the desired location in a well, which then sets to form a cement plug. As used herein, the term “squeeze slurry” refers to introducing a cement slurry into a cured cement sheath having leak paths, so as to plug or fill the leak paths (i.e., a cement squeeze operation). As used herein, the term “liner slurry” refers to a cement slurry that is pumped downhole via the drill or tubing string, via the downhole end of the string and up-hole via the annulus between the casing or liner and the wellbore wall. Otherwise, the cement slurry may be pumped through the inner fluid passage of the casing while being contained between two cement plugs.

Also provided is a method of applying a cement slurry to at least one structural construction element, which method includes the steps of: a) contacting a cement slurry that includes a cement mix, a thickening time modifier selected from calcium sulfate hemihydrate, calcium sulfate dihydrate, anhydrous calcium sulfate, and water in an amount from about 140 wt % to about 300 wt % by weight of cement with the structural construction element and b) allowing the cement slurry to set.

While specific embodiments are discussed, the specification is illustrative only and not restrictive. Many variations of this disclosure will become apparent to those skilled in the art upon review of this specification.

As used herein, and unless otherwise indicated, the term “about” or “approximately” means an acceptable error for a particular value as determined by one of ordinary skill in the art, which depends in part on how the value is measured or determined. In certain embodiments, the term “about” or “approximately” means within 1, 2, 3, or 4 standard deviations. In certain embodiments, the term “about” or “approximately” means within 50%, 20%, 15%, 10%, 9%, 8%, 7%, 6%, 5%, 4%, 3%, 2%, 1%, 0.5%, or 0.05% of a given value or range.

Also, it should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

The present disclosure will further be described by reference to the following examples. The following examples are merely illustrative and are not intended to be limiting. Unless otherwise indicated, all percentages are by weight of the cement or cement blend.

In the examples listed below, cement slurries were blended and tested according to “Recommended Practice for Testing Well Cements”, API RECOMMENDED PRACTICE 10B-2 SECOND EDITION, April 2013.

### EXAMPLE 1

The slurry of Composition 1 included 50:50 Type C Pozzolan fly ash:Class C Portland cement, Bentonite (10 wt % BWOC), Salt (5 wt % by weight of mix water (“BWOW”)) and 16.67 gal/sack mix water (BWOC). The slurry did not contain a thickening time modifier of the present disclosure.

Testing and Results: The initial consistency of the slurry was approximately 4 Bc and remained at 4 Bc for 3.5 hours. The consistency then increased to 5 Bc and remained for 4.5 hours. The consistency then steadily increased to 15 Bc at 7.0 hours, 20 Bc at 10.0 hours and 22 Bc at 12.0 hours. The slurry did not achieve a thickening time at 70 Bc within the 12.0 hour test period. (FIG. 1).

### EXAMPLE 2

The slurry of Composition 2 included 50:50 Type C Pozzolan fly ash:Class C Portland cement, Bentonite (10 wt % BWOC), Salt (5 wt % BWOW), thickening time modifier (calcium sulfate dihydrate) (5 wt % BWOC) and 16.67 gal/sack mix water (BWOC).

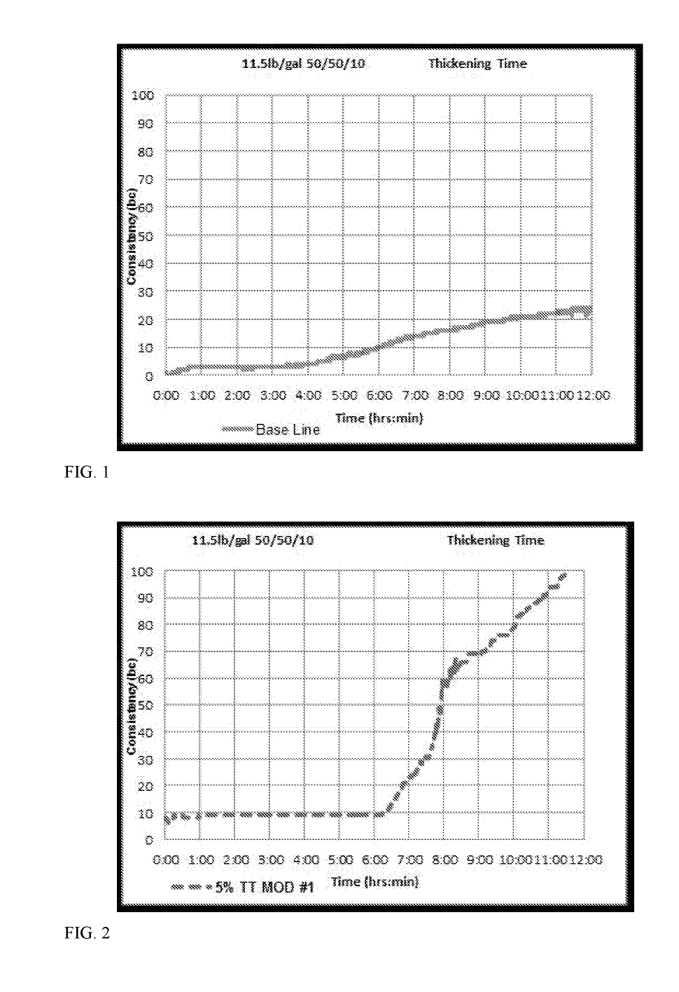

Testing and Results: The initial consistency of the slurry was 10 Bc and remained 10 Bc for 6.25 hours. The consistency then increased from 10 Bc at 6.25 hours to 35 Bc in 7.5 hours. The consistency then increased to 70 Bc at 8.25 hours and to 100 Bc at 11.5 hours. The slurry achieved a thickening time at 70 Bc at 8.25 hours and at 100 Bc at 11.5 hours. (FIG. 2).

### EXAMPLE 3

The slurry of Composition 3 included 50:50 Type C Pozzolan fly ash:Class C Portland cement, Bentonite (10 wt % BWOC), Salt (5 wt % BWOW), thickening time modifier (calcium sulfate dihydrate) (7 wt % BWOC) and 16.67 gal/sack mix water (BWOC).

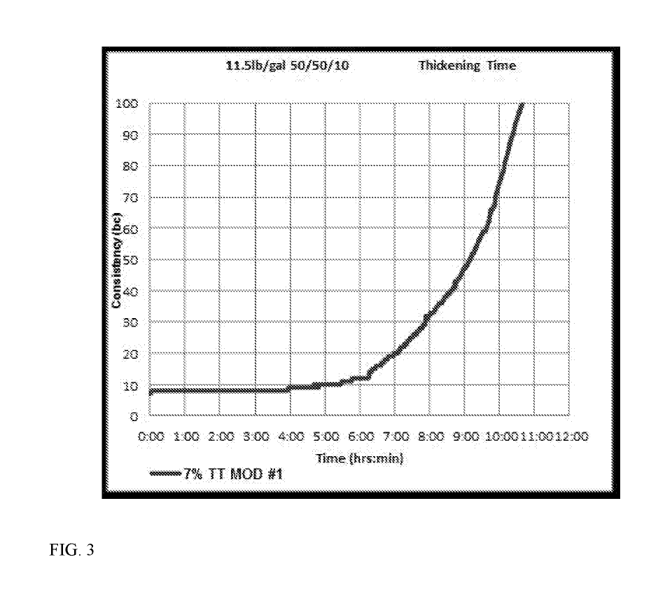

Testing and Results: The initial consistency of the slurry was approximately 2 Bc and remained 2 Bc for 4.5 hours. The consistency then increased from 2 Bc at 4.5 hours to 30 Bc in 6.5 hours. The consistency then increased to 70 Bc at 7.75 hours. The slurry achieved a thickening time at 70 Bc at 7.75 hours and 100 Bc at 10.65 hours. (FIG. 3).

### Test Result Summary

The addition of a thickening time modifier of the present disclosure at 5 wt % and 7 wt % BWOC enabled the cement slurry to achieve a thickening time at 70 Bc, even up to 100 Bc. Without a thickening time modifier of the present disclosure, the cement slurry was incapable of achieving a thickening time of at least 70 Bc, a most common occurrence observed in both pilot and field blend testing.

Thickening time modifiers of the present disclosure did not significantly change the amount of time to reach 70 Bc. For example, the addition of 5 wt % (BWOC) of a thickening time modifier achieved a thickening time at 70 Bc of 8.25 hours as compared with the addition of 7 wt % (BWOC) of a thickening time modifier, which achieved a thickening time at 70 Bc of 7.75 hours.

In addition, the initial consistency and consistency during the liquid state, where the slurry would be pumped in a wellbore, were those expected of a slurry in a composition without a thickening time modifier and, as such, would exhibit normal friction pressures during pumping. For Composition 1 (no thickening time modifier), the initial consistency measured was 4 Bc and remained so for 3.5 hours. The consistency then increased to 5 Bc where it remained to 4.5 hours. The consistency at 12 hours was 22 Bc. This composition did not achieve a thickening time at 70 Bc within 12 hours.

For Composition 2 (thickening time modifier 5 wt % BWOC), the initial consistency was 10 Bc and remained so for 6.25 hours. Composition 2 achieved thickening time at 70 Bc at 8.25 hours.

For Composition 3 (thickening time modifier 7 wt % BWOC), the initial consistency was 2 Bc and remained so for 4.5 hours. Composition 3 achieved thickening time at 70 Bc at 7.75 hours.

The disclosed subject matter has been described with reference to specific details of particular embodiments thereof. It is not intended that such details be regarded as limitations upon the scope of the disclosed subject matter except insofar as and to the extent that they are included in the accompanying claims.

Therefore, the exemplary embodiments described herein are well adapted to attain the ends and advantages mentioned as well as those that are inherent therein. The particular embodiments disclosed above are illustrative only, as the exemplary embodiments described herein may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the exemplary embodiments described herein. The exemplary embodiments described herein illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components, substances and steps. As used herein the term “consisting essentially of” shall be construed to mean including the listed components, substances or steps and such additional components, substances or steps which do not materially affect the basic and novel properties of the composition or method. In some embodiments, a composition in accordance with embodiments of the present disclosure that “consists essentially of” the recited components or substances does not include any additional components or substances that alter the basic and novel properties of the composition. If there is any conflict in the usages of a word or term in this specification and one or more patent or other documents that may be incorporated herein by reference, the definitions that are consistent with this specification should be adopted.

We claim:

1. A method for achieving thickening time in a cement composition comprising: providing a cementitious composition comprising a cement mix and a thickening time modifier selected from the group consisting of calcium sulfate hemihydrate, calcium sulfate dihydrate, anhydrous calcium sulfate, and combinations thereof; combining the cementitious composition with water in an amount from about 140 wt % to about 300 wt % by weight of cement to form a slurry; and allowing the slurry to achieve at least 70 Bearden units of consistency (Bc).

2. The method of claim 1, wherein the cement mix is selected from the group consisting of Portland cement, pozzolana cement, gypsum cement, alumina cement, silica cement, slag cement and high alkalinity cement.

3. The method of claim 1, wherein the thickening time modifier is present in an amount from about 1 wt % to about 20 wt % by total weight of the composition.

4. The method of claim 1, wherein the cementitious composition further comprises one or more additives selected from the group consisting of extenders, accelerators, retarders, fluid loss agents, rheology modifiers, gas migration additives, expansion additives, anti-settling additives, compressive strength enhancers, loss circulation additives, and combinations thereof.

5. A method for cementing comprising: introducing a cement slurry into a wellbore penetrating a subterranean formation, wherein the slurry comprises a cement mix, a thickening time modifier selected from the group consisting of calcium sulfate hemihydrate, calcium sulfate dihydrate, anhydrous calcium sulfate, and water in an amount from about 140 wt % to about 300 wt % by weight of cement; and allowing the slurry to set therein.

6. The method of claim 5 further comprising introducing an aqueous spacer fluid into the wellbore prior to introducing the cement slurry.

7. The method of claim 5, wherein the cement slurry is selected from the group consisting of a lead slurry, a tail slurry, a completion slurry, a scavenger slurry, a plug slurry, a squeeze slurry, and a liner slurry.

8. The method of claim 5, wherein the cement mix is selected from the group consisting of Portland cement, pozzolana cement, gypsum cement, alumina cement, silica cement, slag cement and high alkalinity cement.

9. The method of claim 5, wherein the cementitious composition further comprises one or more additives selected from the group consisting of extenders, accelerators, retarders, fluid loss agents, rheology modifiers, gas migration additives, expansion additives, anti-settling additives, compressive strength enhancers, loss circulation additives, and combinations thereof.

10. The method of claim 5, wherein the slurry is allowed to set in a space between the subterranean formation and a pipe string.

11. The method of claim 5, wherein the cement slurry is introduced into leak paths in a cured cement sheath in the subterranean formation and allowed to set in the leak paths.

12. The method of claim 5, wherein the cement slurry is allowed to set into a solid mass which forms a plug in the wellbore.

13. A method of applying a cement slurry to at least one structural construction element, which method comprises: a) contacting a cement slurry comprising a cement mix, a thickening time modifier selected from the group consisting of calcium sulfate hemihydrate, calcium sulfate dihydrate, anhydrous calcium sulfate, and water in an amount from about 140 wt % to about 300 wt % by weight of cement with the structural construction element and b) allowing the cement slurry to set.
